(19) United States
(12) Patent Application Publication
(10) Pub. No.: US 2020/0394059 A1
(43) Pub. Date: Dec. 17, 2020

(54) REAL-TIME LOCALIZATION

(71) Applicant: ELECTRONIC ARTS INC., Redwood City, CA (US)

(72) Inventor: Kun WEI, Shanghai (CN)

(73) Assignee: Electronic Arts Inc., Redwood City, CA (US)

(21) Appl. No.: 16/076,974

(22) PCT Filed: Jul. 3, 2017
(86) PCT No.: PCT/CN2017/091457

§ 371 Date: Aug. 9, 2018

(51) Int. Cl. G06F 9/451; G06F 16/9537; G06F 16/22; G06F 16/25; H04L 29/08; G06F 40/58

(52) U.S. Cl. CPC G06F 9/454; G06F 16/9537; G06F 40/58; G06F 16/252; H04L 67/18; G06F 16/22

(57) ABSTRACT

Various aspects of the subject technology relate to systems, methods, and machine-readable media for real-time localization. The disclosed system provides for real-time localization of an online product that is released to a client in its native language. The online product may include a native layer where content in the native language is provided as well as a localization layer where the content that has been localized can be provided for display. The localization layer may be superimposed on the native layer such that the content of the native layer is obscured from display. The disclosed system includes determining both the native language and detecting the user's locale so that the disclosed system can provide a localized version of the native content. The client calls a backend translation engine of a server to request for the localized version, and the backend translation engine can respond with the localized version in real-time.

### TECHNICAL FIELD

The present disclosure generally relates to a computer-operated interactive environment, and more particularly to real-time localization in a computer-operated interactive environment.

### BACKGROUND

It is de-facto that online products including websites and online games support global users. This support has commonly been implemented through localization, and usually released with supported language translation resource bundles. The traditional process of localization has required additional engineering efforts, including quality assurance efforts to ensure user interface compatibility and rendering correctness. The traditional process of localization may not detect defects unless reported manually by users, and may require a relatively long cycle to remedy the defects or to release updated resources.

### SUMMARY

The disclosed system provides for real-time localization of an online product that is released to a client in its native spoken language. The online product may include a native layer where content in the native language is provided as well as a localization layer where the content that has been localized (e.g., translated from the native language to a local language) can be provided for display. In some aspects, the localization layer is superimposed on the native layer such that the content of the native layer is obscured from display, thus allowing the content on the localization layer to be visible to the user in its place. The disclosed system includes both determining the native language and detecting the user's locale (e.g., geolocation information) so that the disclosed system can provide a localized version of the native content. The client can call a backend translation engine of a server to request for the localized version, and the backend translation engine can respond with the localized version in real-time.

According to one embodiment of the present disclosure, a computer-implemented method is provided. The method includes loading on a device an application that includes a native layer and a localization layer for display in a user interface of the application. The method also includes receiving a request via the user interface to obtain one or more resources. The method also includes determining geolocation information of the device from the request. The method also includes determining a native language of the application from the native layer. The method also includes determining that one or more areas of the localization layer are tagged with an indication that the one or more areas require localization of the one or more resources. The method also includes initiating a call with a server over a communication channel to the server, in which the initiated call includes a request to a backend translation engine of the server. In some aspects, the request includes an instruction to provide a localized version of the one or more resources corresponding to the tagged one or more areas of the localization layer. In some aspects, the localized version indicates a language translation from the native language to a localized language that corresponds to the determined geolocation information. The method also includes receiving a response from the backend translation engine based on the request. In some aspects, the response includes the localized version of the one or more resources. The method also includes rendering the localized version of the one or more resources. The method also includes providing, for display on the device, a representation of the one or more resources in the native layer and the rendered localized version of the one or more resources in the localization layer.

According to one embodiment of the present disclosure, a non-transitory computer readable storage medium is provided including instructions that, when executed by a processor, cause the processor to perform a method. The method includes determining geolocation information of a device from a first request for a resource. In some aspects, the request is received via a user interface of an application that includes a native layer and a localization layer for display in the user interface. The method also includes determining a native language of the application from the native layer. The method also includes determining that one or more areas of the localization layer are tagged with an indication that the one or more areas require localization of the resource. The method also includes providing, for transmission, a second request to a backend translation engine of a server over a communication channel to the server. In some aspects, the second request includes an instruction to provide a localized version of the resource corresponding to the tagged one or more areas of the localization layer. In some aspects, the localized version indicates a language translation from the native language to a localized language that corresponds to the determined geolocation information. The method also includes receiving, in response to the second request, the localized version of the resource from the backend translation engine. The method also includes rendering the localized version of the resource concurrently with a native version of the resource. The method also includes providing, for display on the device, a representation of the rendered native version of the resource in the native layer and the rendered localized version of the resource in the localization layer.

According to one embodiment of the present disclosure, a system is provided that includes means for storing instructions, and means for executing the stored instructions that, when executed by the means, cause the means to perform a method. The method includes loading on a device an application comprising a native layer and a localization layer for display in a user interface of the application. The method also includes receiving a request via the user interface to obtain one or more resources. The method also includes determining geolocation information of the device from the request. The method also includes determining a native language of the application from the native layer. The method also includes determining that one or more areas of the localization layer are tagged with an indication that the one or more areas require localization of the one or more resources. The method also includes initiating a call with a server over a communication channel to the serer, in which the initiated call includes a request to a backend translation engine of the server. In some aspects, the request includes an instruction to provide a localized version of the one or more resources corresponding to the tagged one or more areas of the localization layer. In some aspects, the localized version indicates a language translation from the native language to a localized language that corresponds to the determined geolocation information. The method also includes receiving a response from the backend translation engine based on the request. In some aspects, the response includes the localized version of the one or more resources. The method also includes rendering the localized version of the one or more resources. The method also includes providing, for display on the device, a representation of the one or more resources in the native layer and the rendered localized version of the one or more resources in the localization layer.

According to one embodiment of the present disclosure, a system is provided including a processor and a memory comprising instructions stored thereon, which when executed by the processor, cause the processor to perform a method. The method includes receiving a request from a client device over a communication channel to the client device, the request indicating geolocation information of a user requesting to obtain one or more resources and a native language of an application associated with the client device from a native layer of the application. The method also includes generating a localized version of the one or more resources that corresponds to one or more areas of a localization layer in the application that are tagged with an indication that the one or more areas require localization of the one or more resources. The method also includes providing, for transmission, the localized version of the one or more resources to the client device over the communication channel. In some aspects, the localized version is rendered with the one or more resources and provided for display in the localization layer concurrently with a representation of the one or more resources in the native layer.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for real-time localization in a computer-operated interactive environment suitable for practicing some implementations of the disclosure.

FIG. 2 is a block diagram illustrating the example device and server from the architecture of FIG. 1 according to certain aspects of the disclosure.

FIG. 3 illustrates an example process of real-time localization in a computer-operated interactive environment using the example client and server of FIG. 2.

FIG. 4 illustrates an example process of real-time localization in a computer-operated interactive environment using the example server of FIG. 2.

FIG. 5 illustrates a schematic diagram for practicing the example process of FIG. 4.

FIGS. 6A and 6B illustrate examples of a real-time localization using a localization layer overlaid on a native layer for practicing the example process of FIG. 4.

FIG. 7 is a block diagram illustrating an example computer system with which the client and server of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

### General Overview

The disclosed system addresses a problem in traditional localization systems tied to computer technology and arising in the realm of computer networks, namely the technical problem of providing a language translation user interface that is consistent with the resources that are native to the geographical location of a particular user. The disclosed system solves this technical problem by providing a solution also rooted in computer technology, namely, by determining both the user locale and the native language of the application that renders the resources. In this respect, the application in its native language can be rendered in the intended localized language in real-time and in a consistent manner.

The disclosed system further provides improvements to the functioning of the computer itself because it saves data storage space, reduces system loading times and reduces the cost of system resources. Specifically, the need for language translation services that are curtailed to the detected user locale and native language upon request in real-time facilitates the savings in storage space by not requiring to keep in storage language resource bundles. The request for language translation services by user locale and native language facilitates the reduction in the cost of system resources and system loading times by either accessing a localized term from a pre-stored complex message or running a translation engine in real-time that accesses specific translation data indexed by the user locale and native language.

### Example System Architecture

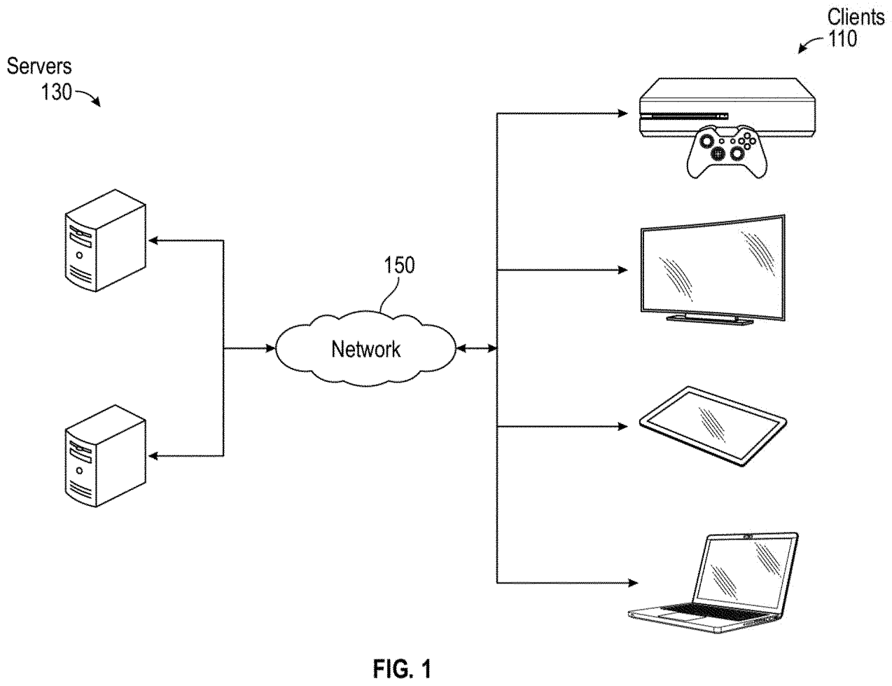

FIG. 1 illustrates an example architecture 100 for real-time localization in a computer-operated interactive environment suitable for practicing some implementations of the disclosure. The architecture 100 includes one or more servers 130 and clients 110 connected over a network 150.

One of the many servers 130 is configured to host real-world data such as programming content and/or streaming content. The servers 130 also may host virtual-world data, such as virtual-world data corresponding to a life simulation and/or first-person strategy simulation. For purposes of load balancing, multiple servers 130 can host the real-world data and the virtual-world data. The server 130 may further be configured to host simulations for multiple clients 110. For example, the server 130 may host a multiplayer simulation for multiple clients 110 to connect to, such that the multiple clients 110 experience the same simulation at approximately the same time.

The clients 110 include one or more computing devices. The clients 110 may include devices capable of running a simulation engine, such as a sports game, for simulating sporting events. For example, the clients 110 may include stationary video game consoles, tablets, mobile devices, laptop computers, desktop computers, and/or other devices capable of running a sports game.

The disclosed system uses virtual-world data from one or more virtual events to drive the life simulation and/or the first-person strategy simulation where users have dominion over the content. The server 130 sends the real-world data and the virtual-world data to one or more clients 110, which uses the real-world data and the virtual-world data in generating and running respective simulations. As such, the disclosed system can, for example, create a fairly accurate simulation of real-life events without requiring a complete digitizing of the real-life event, or an extensive reconfiguration of a simulation engine.

The servers 130 can be any device having an appropriate processor, memory, and communications capability for hosting real-world data. The clients 110 to which the servers 130 are connected over the network 150 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### Example System for Interactive Computer-Operated Agents

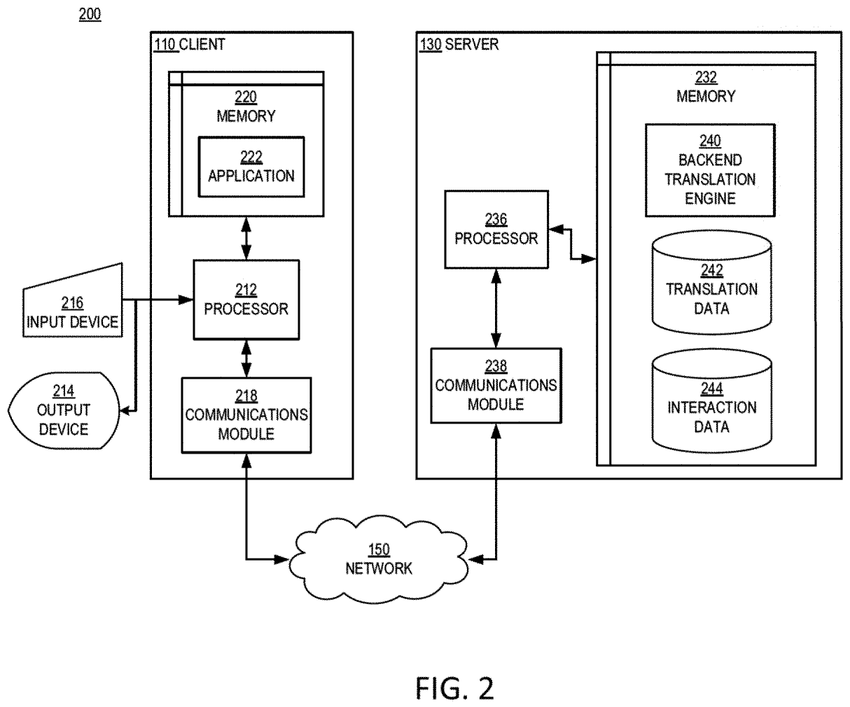

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The server 130 includes a memory 232, a processor 236, and a communications module 238. The memory 232 of the server 130 includes a backend translation engine 240. The processor 236 of the server 130 is configured to execute instructions, such as instructions physically coded into the processor 236, instructions received from software in the memory 232, or a combination of both.

The backend translation engine 240 is configured to perform a language translation service using the locale (or geolocation information) of a particular user and native language associated with an application (e.g., 222). The backend translation engine can perform the language translation service upon a request received from the application 222. In some aspects, the backend translation engine 240 may access a local dictionary or a remote dictionary stored outside of the server 130 to facilitate the language translation service.

The memory 232 also includes translation data repository 242. In one or more implementations, the translation data repository 242 includes a data structure that stores complex data messages indicating translations for one or more predetermined portions of content for a given resource, where each message corresponds to a different localized language. The translation data repository 242 may store a different set of translation terms for each localized language facilitated by the backend translation engine 240, which may be indexed by the geographical location of the particular user. The translation data repository 242 may include a mapping between the areas of a localization layer in the application that are tagged for localization and terms from the set of translation terms that correspond to such tagged areas for more expeditious indexing by the backend translation engine 240.

Also included in the memory 232 of the server 130 is interaction data 244. In certain aspects, the processor 236 is configured to determine the interaction data 244 by obtaining user interaction data identifying interactions between users and the localization layer. In this respect, the interaction data 244 may include user-generated data indicating a preferred translation for a term in the localization language. The interaction data 244 may indicate the number of interactions that a particular user has with the localization layer, the length of time that a particular user has with the localization layer, the number of terms input by a particular user to the localization layer for the rendering of the localized version, and a mapping of one or more replacement terms provided by one or more users with respect to a translated term provided by the backend translation engine for a given native language term.

The client 110 includes a processor 212, the communications module 218, and the memory 220 that includes the application 222. The application 222 may be a streaming engine and/or simulation engine, or physically coded instructions that execute a simulation of a sporting event, such as a sports-themed video game. The client 110 also includes an input device 216, such as a keyboard, mouse, touchscreen and/or game controller, and an output device 214, such as a display. The processor 212 of the client 110 is configured to execute instructions, such as instructions physically coded into the processor 212, instructions received from software in the memory 220, or a combination of both. The processor 212 of the client 110 executes instructions from the application 222 causing the processor 212 to run a real-time localization, where the processor 212, using the application 222, can determine the native language of the application 222 and detect the user's locale (e.g., geolocation information) so that the backend translation engine 240 can provide a localized version of the native content. The client 110, via the application 222, calls the backend translation engine 240 to request for the localized version, and the backend translation engine 240 can respond with the localized version in real-time.

The techniques described herein may be implemented as method(s) that am performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

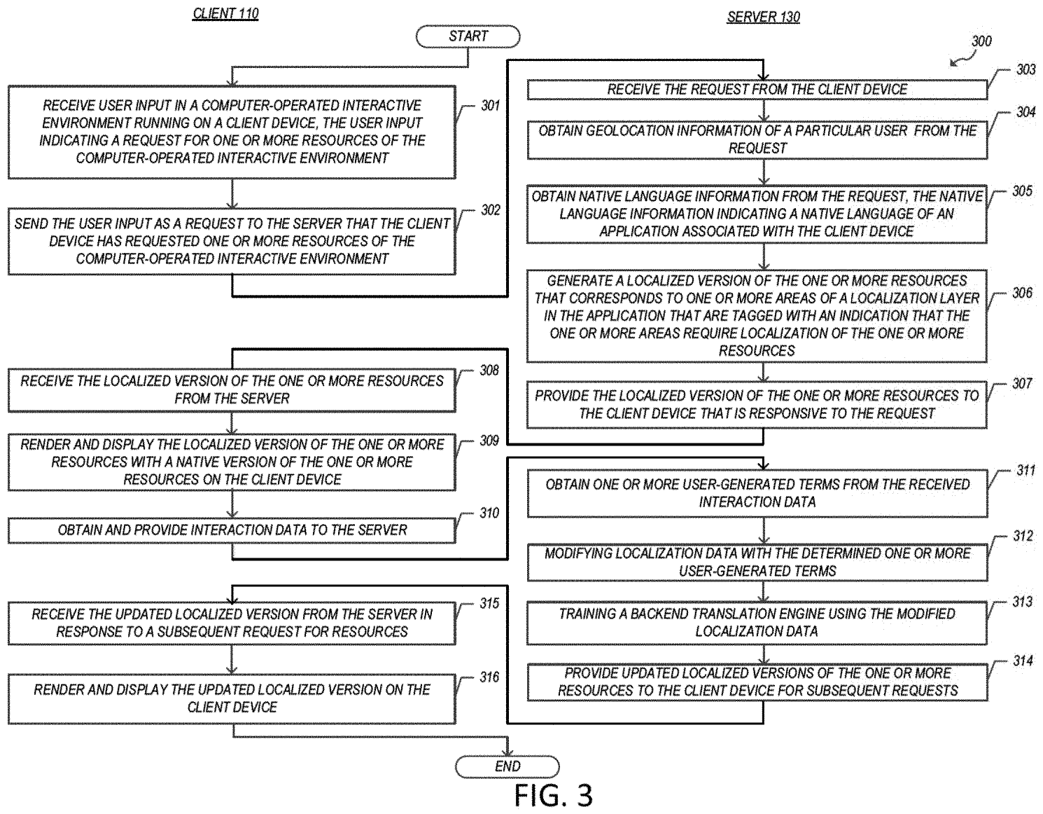

FIG. 3 illustrates an example process 300 of real-time localization in a computer-operated interactive environment using the example client 110 and server 130 of FIG. 2. While FIG. 3 is described with reference to FIG. 2, it should be noted that the process steps of FIG. 3 may be performed by other systems.

The process 300 begins in step 301 when a user, for example, loads an application 222 on a client 110 such as a computer-operated interactive environment running on the client 110, and the client 110 receives an input from the user in using the input device 216. In some implementations, the input indicates a request for one or more resources of the computer-operated interactive environment (e.g., a web page, an online interactive environment simulation, an online streaming service, etc.).

Next, in step 302, the application 222 on the client 110 sends the user input as a request to the server 130 that the client 110 has requested one or more resources of the computer-operated interactive environment. In some aspects, the user's locale and language settings are sent to the server 130 upon the client 110 initializing the request to access a product (such as a user input that includes a text query indicating a product URL or opening a link/icon). Turning to the server 130, in step 303, the server 130 receives the request from the client 110. Subsequently, in step 304, the server 130 obtains geolocation information of a particular user from the request. Depending on the user's locale and language settings, the server 130 can respond with a native-based application and user interface including the localization layer either enabled or disabled.

In some implementations, the localization layer can request for the translation resources a synchronized via Ajax calls while the underlying native layer is loading on the application 222. In some aspects, the Ajax calls may carry over the user locale (including the geolocation information, user-side local settings, etc.) and resource identifiers. The Ajax calls may be initiated independent of any user input via the application 222. Without departing from the scope of the present disclosure, other asynchronous techniques can be performed without interfering with the current state of the native layer.

Next, in step 305, the server 130 obtains native spoken language information from the request. In some aspects, the native language information indicates a native language of the application 222. Subsequently, in step 306, the server 130 generates a localized version of the one or more resources that corresponds to one or more areas of a localization layer in the application 222 that are tagged with an indication that the one or more areas require localization of the one or more resources.

In one or more implementations, the localization layer can be switched on and off. If the user's locale (e.g., the geolocation information) and language settings (e.g., the native language information) are the same as the information and/or content provided in the native layer, then the localization layer may be switched off by default. If the user's locale and language settings are different from the information and/or content provided in the native layer, then the localization layer may be switched on by default. In some aspects, a user associated with the client 110 may be prompted to switch off the localization layer (e.g., a Chinese user can switch off the localization layer if the user is fluent in English).

Next, in step 307, the server 130 provides the localized version of the one or more resources that is responsive to the request to the client 110. Now turning back to the client 110, in step 308, the client 110 receives the localized version of the one or more resources from the server 130. Next, in step 309, the client 110 renders and provides for display the localized version of the one or more resources with a native version of the one or more resources via the application 222 of the client 110. Subsequently, in step 310, the client 110 obtains and provides interaction data to the server 130. In some implementations, the client 110 may change modes (e.g., changed to a local product operation mode) so that user feedback can be collected. In some examples, the user feedback may indicate whether the localized version of the resources provided the wrong translation or poor translation, where this type of user feedback can be transmitted back to the backend translation engine 240 of the server 130.

Turning back to the server 130, in step 311, the server 130 obtains one or more user-generated terms from the received interaction data. Next, in step 312, the server 130 modifies localization data with the determined one or more user-generated terms. Subsequently, in step 313, the server 130 trains a backend translation engine using the modified localization data. In step 314, the server 130 provides updated localized versions of the one or more resources to the client 110 for subsequent requests.

In step 315, the client 110 receives an updated localized version from the server 130 in response to a subsequent request for resources. Subsequently, in step 316, the client 110 renders and displays the updated localized version of the resources via the application 222 of the client 110.

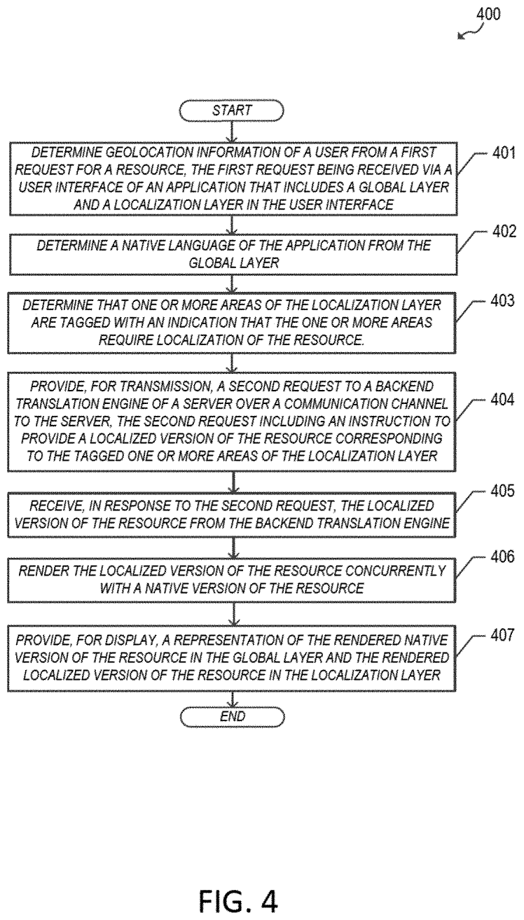

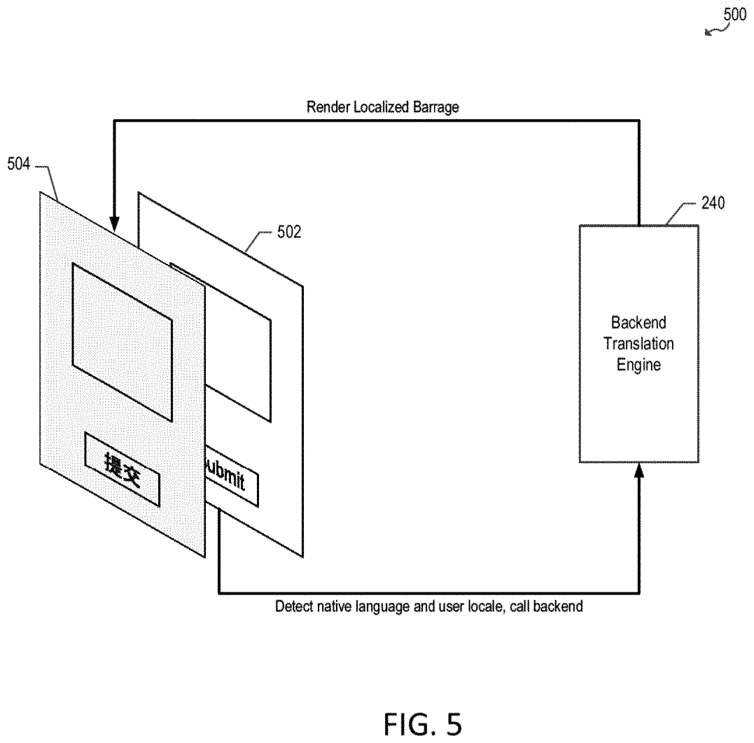

FIG. 4 illustrates an example process 400 of real-time localization in a computer-operated interactive environment using the example client 110 of FIG. 2. For explanatory purposes, the example process 400 is described herein with reference to the processor 212 of FIG. 2; however, the example process 400 is not limited to the processor 212 of FIG. 2, and one or more blocks of the example process 400 may be performed by one or more other components of the server 130, such as the processor 236. Further for explanatory purposes, the blocks of the example process 400 are described herein as occurring in serial, or linearly. However, multiple blocks of the example process 400 may occur in parallel. In addition, the blocks of the example process 400 need not be performed in the order shown and/or one or more of the blocks of the example process 400 need not be performed. For purposes of explanation of the subject technology, the process 400 will be discussed in reference to FIG. 5.

FIG. 5 illustrates a schematic diagram 500 for practicing the example process 400 of FIG. 4. A client device (e.g., client 110) can establish a connection to a server (e.g., 130) to receive a resource for rendering and display on a user interface of an application (e.g., 222) of the client 110. The user interface includes a native layer (e.g., 502) that includes content in a native language and a localization layer (e.g., 504) that is configured to be overlaid over the native layer to display the content in a localized language such that the localization layer 504 provides real-time localization of the content from the resource. In one or more implementations, the native layer is a global layer with a native user interface in the native language.

Referring back to FIG. 4, in step 401, using the application 222, the processor 212 of the client 110 determines geolocation information of a user from a first request for a resource. In some aspects, the request is received via the user interface of the application 222 that includes the native layer 502 and the localization layer 504 in the user interface.

At step 402, the processor 212 determines a native language of the application from the native layer. For example, the native language of the application may be English. However, the geolocation information of the user indicates that the user is geographically located in a region where the language is different from the native language of the application. In this respect, the resources should be displayed in a language that corresponds to the geolocation of the user (e.g., Mandarin, Korean, Spanish, German, etc.).

Next at step 403, the processor 212 determines that one or more areas of the localization layer are tagged with an indication that the one or more areas require localization of the resource. For example, the localization layer may identify in advance which corresponding portions on the native layer contain content that needs to be translated from the native language to the localized language. In this respect, the indexing of the translated portions when requested by the client 110 can be expedited and, therefore, reduce latency in the overall system.

Subsequently, at step 404, the processor 212 provides, for transmission, a second request to a backend translation engine of a server over a communication channel to the server. In some aspects, the second request includes an instruction to provide a localized version of the resource corresponding to the tagged one or more areas of the localization layer. In other aspects, the localized version indicates a language translation from the native language to the localized language (e.g., Mandarin) that corresponds to the determined geolocation information (e.g., a geographical region in China).

At step 405, the processor 212 receives, in response to the second request, the localized version of the resource from the backend translation engine. Next, at step 406, the processor 212 renders the localized version of the resource concurrently with a native version of the resource. Subsequently, at step 407, the processor 212 provides, for display, a representation of the rendered native version of the resource in the native layer and the rendered localized version of the resource in the localization layer.

In one or more implementations, the processor 212, using the application 222, removes content in the native language from the native layer, the content is removed from areas in the native layer that correspond to the tagged one or more areas of the localization layer.

In some aspects, the localization layer is superimposed on the native layer. In other aspects, content of the native layer that corresponds to the tagged one or more areas of the localization layer are obscured from display by the localization layer.

In one or more implementations, the processor 212, using the application 222, obtains user interaction data associated with the rendered localized version of the one or more resources.

In some aspects, the processor 212 modifies localization data, which is accessible to the backend translation engine over the communication channel, using the obtained user interaction data. In other aspects, the backend translation engine is trained with the modified localization data.

In one or more implementations, in rendering the localized version, the processor 212, using the application 222, the processor 212 selects one or more translated portions from the localized version of the one or more resources over corresponding objects from the native layer. In some aspects, the processor 212 renders the localization layer with the selected one or more translated portions.

In one or more implementations, the processor 212 renders synchronizing content in the localization layer to corresponding content in the native layer. In some aspects, the content in the localization layer includes one or more identifiers. In this respect, the content in the localization layer may be synchronized to the content in the native layer based on each of the one or more identifiers in the localization layer aligning to a corresponding identifier in the native layer.

In some aspects, the localized version of the one or more resources is generated prior to the request being sent to the backend translation engine. In other aspects, the localized version is stored in one or more indexes of a data structure accessible to the backend translation engine.

In some aspects, the localized version of the one or more resources is indexed by an identifier associated with the localization layer. In other aspects, the identifier indicating a mapping between the one or more resources and the geolocation information.

In one or more implementations, the processor 236 of the server 130 may receive a request from a client device (e.g., client 110) over a communication channel to the client device. The request may indicate geolocation information of a user requesting to obtain one or more resources and a native language of an application (e.g., 222) associated with the client 110 from a native layer (e.g., 502) of the application 222. The backend translation engine (e.g., 240) can generate a localized version of the one or more resources that corresponds to one or more areas of a localization layer (e.g., 504) in the application 222 that are tagged with an indication that the one or more areas require localization of the one or more resources. The server 130 can provide, for transmission, the localized version of the one or more resources to the client 110 over the communication channel. In some aspects, the localized version may be rendered with the one or more resources and provided for display in the localization layer (e.g., 504) concurrently with a representation of the one or more resources in the native layer (e.g., 502).

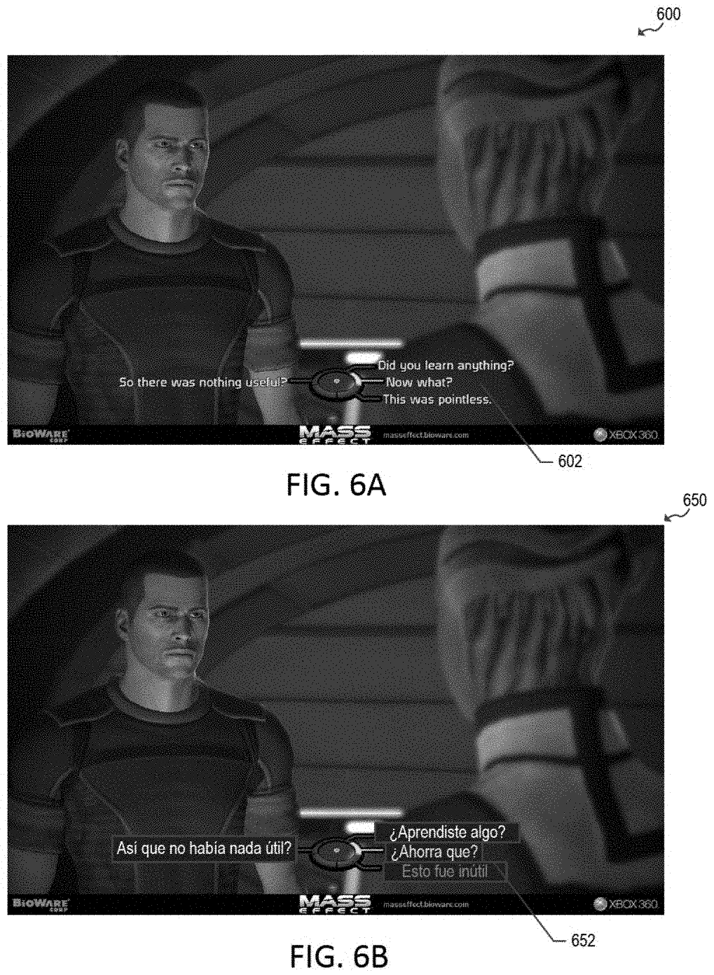

FIG. 6A illustrates an example of a user interface 600 with a native layer (e.g., 502). The user interface 600 includes a screen capture of content rendered in a native version that is provided for display on the native layer in the user interface 600 of an application (e.g., the application 222). The screen capture illustrates a frame (e.g., 602) from a video stream (or programming content) that may include an audio stream in a native spoken language. In some aspects, the screen capture is provided for display on the native layer such that native content is rendered in the native layer.

FIG. 6B illustrates an example of a user interface 650 with real-time localization using a localization layer (e.g., 504) overlaid on the native layer (e.g., 502) for practicing the example process of FIG. 4. The user interface 650 includes the screen capture of the content rendered in the native version that is provided for display on the native layer in the user interface 650 of the application. The localization layer includes content that indicates a translation from the native language to the localized language. In the screen capture, the localization layer with content in the localized language (e.g., 652) is superimposed over the native layer with the native content. In some aspects, visual content such as text or alphanumeric symbols am obscured from display when the localization layer is superimposed on the native layer. In other aspects, the native audio of the native layer may be replaced by a different audio stream in the localized language. In some aspects, the native audio may instead be replaced by visual content on the localization layer (without additional audio streams). By way of example, the native content in English (e.g., FIG. 6A) has been obscured by the localization layer containing the translated content in Spanish. Without departing from the scope of the present disclosure, the translation services provided by the backend translation engine 240 include an arbitrary number of spoken languages that can be selected by default by the backend translation engine 240 in some implementations, or reconfigured by a user via the application 222 in other implementations.

### Hardware Overview

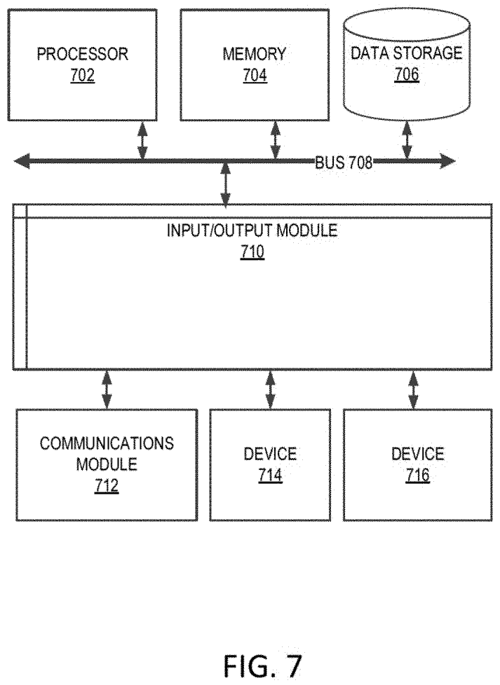

FIG. 7 is a block diagram illustrating an exemplary computer system 700 with which the client 110 and server 130 of FIG. 1 can be implemented. In certain aspects, the computer system 700 may be implemented using hardware or a combination of software and hardware, either in a dedicated server, integrated into another entity, or distributed across multiple entities.

Computer system 700 (e.g., client 110 and server 130) includes a bus 708 or other communication mechanism for communicating information, and a processor 702 (e.g., processor 212 and 236) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 (e.g., communications modules 218 and 238) include networking interface cards, such as Ethernet cards and modems. In certain aspects, the input/output module 710 is configured to connect to a plurality of devices, such as an input device 714 (e.g., input device 216) and/or an output device 716 (e.g., output device 214). Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as a LCD (liquid crystal display) monitor, for displaying information to the user.

According to one aspect of the present disclosure, the client 110 and server 130 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that am described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and am within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
loading, on a device, an application comprising a native layer and a localization layer for display in a user interface of the application;
receiving a request via the user interface to obtain one or more resources;
determining geolocation information of the device from the request;
determining a native language of the application from the native layer;
determining that one or more areas of the localization layer are tagged with an indication that the one or more areas require localization of the one or more resources;
initiating a call with a server over a communication channel to the server, the initiated call including a request to a backend translation engine of the server, the request including an instruction to provide a localized version of the one or more resources corresponding to the tagged one or more areas of the localization layer, the localized version indicating a language translation from the native language to a localized language that corresponds to the determined geolocation information;
receiving a response from the backend translation engine based on the request, the response comprising the localized version of the one or more resources;
rendering the localized version of the one or more resources; and
providing, for display on the device, a representation of the one or more resources in the native layer and the rendered localized version of the one or more resources in the localization layer.

2. The computer-implemented method of claim 1, further comprising:
removing content in the native language from the native layer, the content being removed from areas in the native layer that correspond to the tagged one or more areas of the localization layer.

3. The computer-implemented method of claim 1, wherein the localization layer is superimposed on the native layer, wherein content of the native layer that corresponds to the tagged one or more areas of the localization layer is obscured from display by the localization layer.

4. The computer-implemented method of claim 1, further comprising:
obtaining user interaction data associated with the rendered localized version of the one or more resources; and
modifying localization data accessible to the backend translation engine using the obtained user interaction data, wherein the backend translation engine is trained with the modified localization data.

5. The computer-implemented method of claim 1, wherein the rendering comprises:
selecting one or more translated portions from the localized version of the one or more resources over corresponding objects from the native layer; and
rendering the localization layer with the selected one or more translated portions.

6. The computer-implemented method of claim 1, wherein the rendering comprises:
synchronizing content in the localization layer to corresponding content in the native layer.

7. The computer-implemented method of claim 6, wherein the content in the localization layer includes one or more identifiers, and wherein the content in the localization layer is synchronized to the content in the native layer based on each of the one or more identifiers in the localization layer aligning to a corresponding identifier in the native layer.

8. The computer-implemented method of claim 1, wherein the localized version of the one or more resources is generated prior to the request being sent to the backend translation engine, and wherein the localized version is stored in one or mom indexes of a data structure accessible to the backend translation engine.

9. The computer-implemented method of claim 8, wherein the localized version of the one or more resources is indexed by an identifier associated with the localization layer, the identifier indicating a mapping between the one or more resources and the geolocation information.

10. A non-transitory computer readable storage medium is provided including instructions that, when executed by a processor, cause the processor to perform a method, the method comprising:
determining geolocation information of a device from a first request for a resource, the first request being received via a user interface of an application running on the device that includes a native layer and a localization layer for display in the user interface;
determining a native language of the application from the native layer;
determining that one or more areas of the localization layer are tagged with an indication that the one or more areas require localization of the resource;
providing, for transmission, a second request to a backend translation engine of a server over a communication channel to the server, the second request comprising an instruction to provide a localized version of the resource corresponding to the tagged one or more areas of the localization layer, the localized version indicating a language translation from the native language to a localized language that corresponds to the determined geolocation information;
receiving, in response to the second request, the localized version of the resource from the backend translation engine;
rendering the localized version of the resource concurrently with a native version of the resource; and
providing, for display on the device, a representation of the rendered native version of the resource in the native layer and the rendered localized version of the resource in the localization layer.

11. The non-transitory computer readable storage medium of claim 10, wherein the instructions further cause the processor to,
remove content in the native language from the native layer, the content being removed from areas in the native layer that correspond to the tagged one or more areas of the localization layer.

12. The non-transitory computer readable storage medium of claim 10, wherein the localization layer is superimposed on the native layer, and wherein content of the native layer that corresponds to the tagged one or more areas of the localization layer are obscured from display by the localization layer.

13. The non-transitory computer readable storage medium of claim 10, wherein the instructions further cause the processor to:
obtain user interaction data associated with the rendered localized version of the resource; and
modify localization data accessible to the backend translation engine using the obtained user interaction data, wherein the backend translation engine is trained with the modified localization data.

14. The non-transitory computer readable storage medium of claim 10, wherein content in the localization layer includes one or more identifiers, and wherein the content in the localization layer is synchronized to the content in the native layer based on each of the one or more identifiers in the localization layer aligning to a corresponding identifier in the native layer.

15. A system, comprising:
a processor; and
a memory comprising instructions stored thereon, which when executed by the processor, cause the processor to:
receive a request from a client device over a communication channel to the client device, the request indicating geolocation information of a user requesting to obtain one or more resources and a native language of an application associated with the client device from a native layer of the application;
generate a localized version of the one or more resources that corresponds to one or more areas of a localization layer in the application that are tagged with an indication that the one or more areas require localization of the one or more resources; and
provide, for transmission, the localized version of the one or more resources to the client device over the communication channel, the localized version being rendered with the one or more resources and provided for display in the localization layer concurrently with a representation of the one or more resources in the native layer.

16. The system of claim 15, wherein the localized version of the one or more resources is generated using a backend translation engine that is configured to perform a language translation of content in the native layer from the native language to a localized language that corresponds to the geolocation information.

17. The system of claim 16, wherein the instructions further cause the processor to:
obtain user interaction data associated with the localized version of the one or more resources;
modify localization data accessible to the backend translation engine using the obtained user interaction data; and
train the backend translation engine with the modified localization data.

18. The system of claim 17, wherein the instructions further cause the processor to:
obtain one or more user-generated terms from the received interaction data,
wherein each of the one or more user-generated terms indicates a respective translation of a term in the native language to the localized language, and
wherein the localization data is modified using the determined one or more user-generated terms.

19. The system of claim 16, wherein the instructions further cause the processor to:
generate a plurality of localized versions for the one or more resources, each of the one or more resources being associated with one of the plurality of localized versions,
wherein the plurality of localized versions are generated prior to the request being sent to the backend translation engine, and
wherein the plurality of localized versions are stored in respective indexes of a data structure accessible to the backend translation engine.

20. The system of claim 19, wherein each of the plurality of localized versions is indexed by a different identifier associated with the localization layer, each of the different identifiers indicating a mapping between the one or more resources and different geolocation information.
